(19) United States
(12) Patent Application Publication
(10) Pub. No.: US 2015/0373306 A1
(43) Pub. Date: Dec. 24, 2015

(54) REAL-TIME VIDEO CAPTURE OF FIELD SPORTS ACTIVITIES

(71) Applicant: OnDeck Digital LLC, Irvine, CA (US)

(72) Inventors: RANDY FLORES, Irvine, CA (US); PIERSON E. CLAIR, IV, Irvine, CA (US); SAMUEL P. STEVENS, Irvine, CA (US)

(73) Assignee: ONDECK DIGITAL LLC, Irvine, CA (US)

(21) Appl. No.: 14/746,492

(22) Filed: Jun. 22, 2015

Related U.S. Application Data
(60) Provisional application No. 62/015,135, filed on Jun. 20, 2014.

(51) Int. Cl. H04N 7/18; H04N 5/76; G06K 9/00; H04N 5/44

(52) U.S. Cl. CPC H04N 7/181; H04N 5/44; H04N 5/76; G06K 9/00718

(57) ABSTRACT

A system and method for video capture of a field sport activity includes a plurality of cameras deployed on a field, an operator interface configured to communicate with said plurality of cameras, and a database configured to collect game situation data and video data captured by said plurality of cameras.

### CROSS-REFERENCE TO RELATED APPLICATIONS

This application claims the benefit of and priority to U.S. Provisional Patent Application Ser. No. 62/015,135 filed on Jun. 20, 2014, the contents of which are incorporated herein by reference.

### TECHNICAL FIELD

The disclosed embodiments relate generally to real-time video capture of field sports activities, and more particularly to a subscription based video system that programmatically captures from a plurality of camera angles that cover a sports field.

### BACKGROUND

Consumers today utilize video technology to capture, share, archive, and relive events of their lives. From the mundane to the special, video technology captures it all in today's hyper-connected environment. Unfortunately, for the 10 million boys and girls that annually participate in field sports, the video capture of their sport has not kept pace with consumer demands. Instead, whether it is for pure entertainment, coaching, or scouting players, today's video solutions are limited to a single angle view-with few options for a user experience that matches how they interact with video in other aspects of their lives. Thus, there exists a need to capture a game utilizing a plurality of angles of synchronized video.

### BRIEF SUMMARY OF EMBODIMENTS

By way of example and not limitation, one aspect of real-time video capture of field sports activities is disclosed. The method can include deploying a plurality of cameras on a field, wherein said plurality of cameras are each configured to transmit a video stream to a mass storage device, triggering the collection of said video streams from an operator interface, storing said video streams onto said mass storage device as a synchronized capture set, and recording a game situation that is indexed to said synchronized capture set.

In another aspect of the disclosure, a system for video capture of a field sport activity is disclosed. The system can include a plurality of cameras deployed on a field, an operator interface configured to communicate with said plurality of cameras, and a database configured to collect game situation data and video data captured by said plurality of cameras.

In general, the disclosed system merges data and video onsite, providing customized, edited video to subscribing customers in unprecedented turnaround time to the device of their choice, such as, by way of non-limiting examples, iPhone, iPad, Android-devices, Kindle, PCs, Macs, etc. By the present disclosure, viewers may now watch an entire baseball game condensed into as little as 22 minutes. Parents on business trips never have to miss a game. Players can create a digital video archive. Coaches have in-game video. Everyone engages with their game video in a way that matches how they interact with technology everywhere else in their lives.

Although the disclosure herein explained and detailed with respect to the game of baseball, as any person of ordinary skill can readily determine, the teachings herein disclosed may also be applicable to an assorted variety of athletic events, including by way of non-limiting examples, football, cricket, soccer, rugby, hockey, tennis, and basketball. To provide this solution, a plurality of digital video cameras capture an entire game. Specifically, in a baseball context, cameras may be set to focus on at least the batter, the pitcher, and the entire field. A single person may operate all cameras by using the disclosed system via, for example, a touchscreen monitor or any other method of data input known in the art. Video and data may then be instantly merged into clips. Concurrently with the game, or at any time postgame, the video may be transmitted to cloud servers where it is hosted and made accessible to subscribers. The system further manages user accounts, archives the video, and may serve as a hub for a user's video experience. For example, the user—player, coach, parent, or fan—may pick a subscription that provides condensed games of their favorite team, or, they may opt to “follow” their favorite players, viewing only the specific appearances of their chosen players. Search filters may also bring only the chosen clips to the user.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The technology disclosed herein, in accordance with one or more various embodiments, is described in detail with reference to the following figures. The drawings are provided for purposes of illustration only and merely depict typical or example embodiments of the disclosed technology. These drawings are provided to facilitate the reader's understanding of the disclosed technology and shall not be considered limiting of the breadth, scope, or applicability thereof. It should be noted that for clarity and ease of illustration these drawings are not necessarily made to scale.

FIG. 1 is a block diagram illustrating a system for real-time video capture of an athletic event, consistent with embodiments disclosed herein.

FIG. 2 is a top-down diagram illustrating data capture devices from a system for real-time capture of an athletic event as deployed on a baseball field, consistent with embodiments disclosed herein.

FIG. 3 illustrates an example layout of a user interface screen consistent with embodiments disclosed herein.

FIG. 4 illustrates an example layout of a user interface screen consistent with embodiments disclosed herein.

FIG. 5A illustrates an example layout of a user interface screen consistent with embodiments disclosed herein.

FIG. 5B illustrates an example layout of a user interface screen consistent with embodiments disclosed herein.

FIG. 5C illustrates an example layout of a user interface screen consistent with embodiments disclosed herein.

FIG. 5D illustrates an example layout of a user interface screen consistent with embodiments disclosed herein.

FIG. 5E illustrates an example layout of a user interface screen consistent with embodiments disclosed herein.

FIG. 5F illustrates an example layout of a user interface screen consistent with embodiments disclosed herein.

FIG. 5G illustrates an example layout of a user interface screen consistent with embodiments disclosed herein.

FIG. 5H illustrates an example layout of a user interface screen consistent with embodiments disclosed herein.

FIG. 5I illustrates an example layout of a user interface screen consistent with embodiments disclosed herein.

FIG. 5J illustrates an example layout of a user interface screen consistent with embodiments disclosed herein.

FIG. 6 illustrates a synchronization plot of a data syncing operation consistent with embodiments disclosed herein.

FIG. 7 illustrates an example computing module that may be used in implementing various features of embodiments of the disclosed technology.

The figures are not intended to be exhaustive or to limit the invention to the precise form disclosed. The figures are not drawn to scale. It should be understood that the disclosed technology can be practiced with modification and alteration, and that the disclosed technology be limited only by the claims and the equivalents thereof.

### DETAILED DESCRIPTION OF THE EMBODIMENTS

The technology disclosed herein is directed towards video processing, and more specifically towards a system and method for real-time video capture and display of an athletic event. In some examples, the athletic event may be a baseball game. Accordingly, for illustrative purposes, systems and methods disclosed herein are discussed in the context of a baseball game to facilitate understanding. However, the athletic event may also be a football game, a soccer game, a hockey game, a basketball game, a tennis match, a gymnastics competition, a track and field competition, or any other athletic event. Some embodiments of this disclosure may also be directed towards non-athletic events for training or viewing purposes, as would be apparent to one of ordinary skill in the art (e.g., theater, film, television, documentary, or other content forms wherein a shortened compilation of multiple contemporaneous video streams would be useful).

Some embodiments of this disclosure provide a system for real-time video capture and display that includes a plurality of data acquisition devices, a tagging device, a control server, a database, a data store, and a user interface device. Each data acquisition device may be configured to contemporaneously capture a data set relating to the athletic event. For example, the data acquisition devices may be digital video cameras and the data sets may be video streams captured by the video camera. In some examples, the data acquisition devices may include inexpensive mobile cameras, standard video cameras, high frame rate cameras, ultra-high frame rate cameras, or high definition cameras.

The data acquisition devices may also include a radar gun to capture pitch speed, hit speed, or bat speed. The data acquisition devices may also include barcode scanners, QR code scanners, or RFID scanners to capture information about individual athletes (i.e., a player-of-interest) by correlating a scanned code with the player-of-interest's name, position, demographic information, and/or related historical data, as stored in a database included in the system.

Each data acquisition device may be strategically located on the playing field and positioned to capture a specific data set related to a player-of-interest. For example, a first data acquisition device may be positioned in an area behind home plate and positioned with a direct line-of-sight to the pitching mound as to capture a first player-of-interest (e.g., the pitcher) executing a first action-of-interest (e.g., delivering a pitch).

A second data acquisition device may be positioned in the right field foul area, along the first base line, and a third data acquisition device may be positioned in the left field foul area, along the third base line. Each of these data acquisition devices may have a direct line of site across home plate to the opposite batter's box to capture a second player-of-interest (e.g., a batter) executing a second action-of-interest (e.g., swinging the bat in an attempt to hit the oncoming pitch).

Yet a fourth data acquisition device may be positioned in the outfield with a full view of the playing field, including both the pitcher and the batter. Fifth and sixth data acquisition devices may be positioned in the left field and/or right field foul areas such that they have a direct line-of-sight to the pitching mound to capture a side view of the pitcher delivering a pitch. Additional cameras may be incorporated and positioned throughout or on the perimeter of the playing field, or any nearby location, as to have a line-of-sight to a player-of-interest on the playing field. A player-of-interest may be any player on the playing field. In some examples, every player on the playing field may be viewed using a digital camera, and the digital camera may be additionally configured to automatically track the player's movement on the playing field.

In some embodiments, the tagger device may be configured to accept a user input that labels each data segment with one or more meta data tags, and transmit each of the meta data tags to the control server. For example, the tagger device may be a mobile computing device, such as a mobile phone, a PDA, a tablet, or other computing device as known in the art. For ease of use, the tagging device may incorporate a touch screen, or other intuitive user input device. The tagging device may receive full data sets, or data segments, from the control server. The meta data tags may include a player-of-interest's name, position, demographic information, an action-of-interest type, or an action-of-interest result. For example, the action-of-interest type may be pitching or batting, and the action-of-interest result may be delivering a strike, a ball, hitting the ball in play, hitting a home run, hitting a foul ball, swinging and missing, and so on.

A user interface device may be configured to control a data acquisition state of each data acquisition device, interface with the control server, and receive a multi-content display window from the control server. For example, the user interface device may be a mobile phone, a PDA, a tablet, or other computing device as known in the art. The user interface device may include a graphical user interface displaying raw and/or processed content from one or more of the data acquisition devices, and enable direct control (e.g., start recording or stop recording) for each individual device. In some embodiments, the tagger and the user interface device may be the same device.

The system also includes a control server. The control server may be configured to receive the data sets, store the data sets in the data store, parse each data set into a plurality of data segments, and index the plurality of data segments in the database. For example, the data sets may be transmitted directly from the data acquisition device that acquired the data set to the control server via standard communications protocols such as BLUETOOTH, Wi-Fi, 3G, 4G, TCP/IP, HTTP, HTTPS, FTP, Secure FTP, or other wireless and/or Internet-based communications protocols as generally known in the art. Alternatively, the data sets may be uploaded to the control server using physical data storage media to transfer each data set from the data acquisition device that acquired the data set to the control server. Other methods of transferring data from the data acquisition device to the control server may be used as known in the art.

The control server may then store the data in the data store, also using known data transfer protocols. In some examples, the data store is a local hard drive. In other examples, the data store may be a Storage Area Network (SAN), Network Attached Storage (NAS), cloud-based storage, or other data storage device as known in the art. Storing the data sets may include encrypting the data sets. The control server may then parse the data into a plurality of data segments. The parsing function may be accomplished via manual user input whereby a user views one or more of the data sets through a user interface and selects starting and stopping points for each data segment. Alternatively, the control server may use saliency recognition algorithms, as generally known in the art, to identify when certain types of motions (e.g., winding up to deliver a pitch or starting to execute a swing of the bat) start and stop, and may then automatically parse the data set into a plurality of data segments according to those detected starting and stopping points. The control server may then index these data segments into a database.

In some embodiments, the control server may be remotely located from the field of play (e.g., in a data center, in the cloud, or other secure location). Alternatively, the control server, or a control server annex, may be locally located on or near the field of play. Some embodiments include both a local control server and a remote control server. The control server may include a video processing engine, a data merging engine, and a rendering engine. The video processing engine may be configured to process one or more of the data segments into one or more video streams according to a user input. The data merging engine may be configured to synchronize each data segment with one or more corresponding meta data tags and one or more data segments acquired from a different data acquisition device. For example, the synchronization process may trigger off of manually entered start and stop points, or a synch flag that a user identifies within each data set.

Alternatively, the synchronization process may be automatically calculated using a saliency recognition algorithm to detect the start of each action-of-interest as captured from each data acquisition device (e.g., the saliency recognition algorithm may detect the start of the pitcher's windup and the pitcher's release of the baseball in a first data set from the first data acquisition device, and then detect the appearance of the baseball over home plate and the swing of a baseball bat in a second data set from the second data acquisition device). The start of each action-of-interest may then be used as a sync point to map the data segments from each data acquisition device to an anticipated action-of-interest timeline (e.g., mapping out the expected timeframe for each event to occur from a pitch being initiated to a batter's swing and hit or miss).

The rendering engine may be configured to generate the multi-content display window comprising a synchronized content. This multi-content display may be transmitted to a user interface device for review and interaction. For example, the multi-content display window may be transmitted to the user interface device via the Internet using standard Internet protocol such as HTTP or HTTPS, as generally known in the art.

Some embodiments of the disclosure provide a method for video capture and display that includes locating a plurality of digital cameras on a playing field such that each digital camera is positioned to capture a distinct field of view of a player-of-interest. The also includes selectively initiating contemporaneous video capture of one or more video streams, wherein each video stream captures an action-of-interest executed by the player-of-interest. For example, the action-of-interest may be any standard action typically executed by a player in a baseball game, such as delivering a pitch, attempting to hit the delivered pitch, fielding a ball, making a throw to attempt to get a runner out, stealing a base, catching a fly ball, or other actions-of-interest as known in the art. Similarly, the player-of-interest may be any player, such as a batter, base-runner, pitcher, infielder, or outfielder.

The method may also include storing the video streams on a data store and generating one or more meta data tags corresponding to each video stream. The meta data tags may include information about the player-of-interest such as the player's name, position, demographic information, and historical data. The meta data tags may also include information about the action-of-interest such as what type of action occurred, and what result occurred. For example, the result may be a strike, a ball, a hit, a miss, a foul ball, an out, or other results as would be known in the art.

The method may also include receiving, with a control server, the one or more video streams and the one or more meta data tags. The control server may be consistent with the control server described above, or other embodiments disclosed herein. The method may further include synchronizing, with a data merging engine, each video stream with one or more corresponding meta data tags and one or more video streams acquired from a different digital camera. The method may further include generating, with a rendering engine, a multi-content display window comprising a synchronized content display of a plurality of the video streams and a plurality of the meta data tags.

In some embodiments, the method may also include generating one or more meta data tags by tagging video stream data using a tagging device, capturing pitch speed using a radar gun device, identifying the player-of-interest name using facial recognition, identifying the player-of-interest name using shape recognition of jersey numbers, identifying the player-of-interest name using a barcode scanner to scan a bar code on a player-of-interest's jersey, identifying the player-of-interest name using a radio frequency identification (RFID) scanner to scan a RFID on a player-of-interest's article of clothing, or identifying the activity-of-interest result using an umpire user interface device.

Several example embodiments of the disclosure are forth below in connection with the appended drawings. These example embodiments are not intended to represent the only embodiments in which the disclosed technology may be practiced. The detailed description includes specific details for the purpose of providing a thorough understanding of the disclosed technology. However, it will be apparent to those skilled in the art that the present invention may be practiced without these specific details.

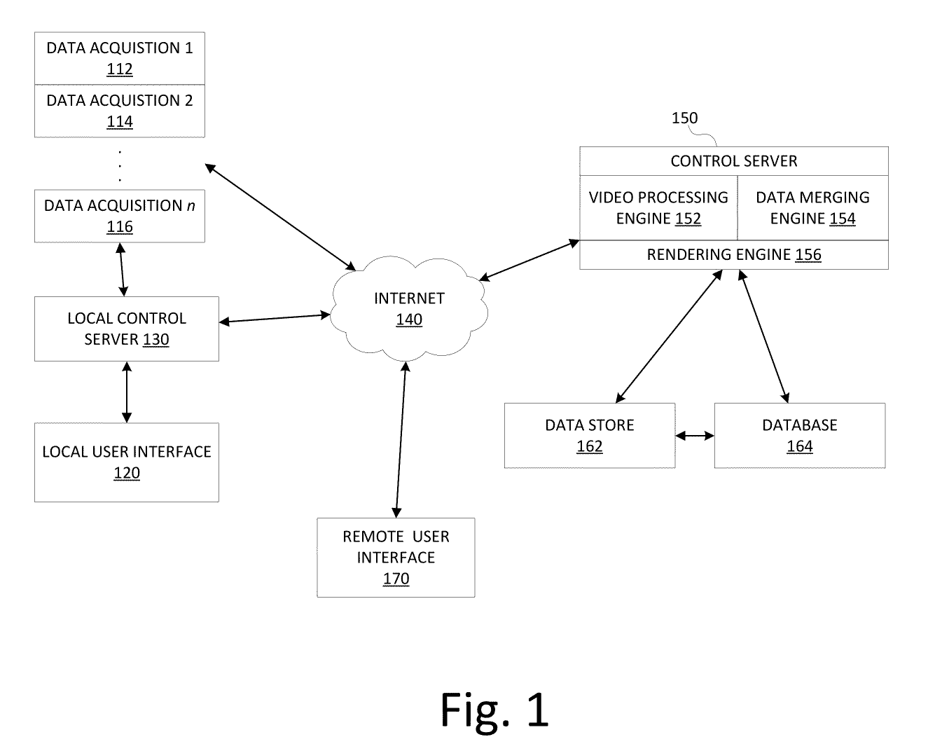

FIG. 1 is a block diagram illustrating a system for real-time video capture of an athletic event. As illustrated, the system may include a plurality of data acquisition devices, labeled data acquisition 1 (112), data acquisition 2 (114), through data acquisition n (116). While the system may function with only one data acquisition device, a plurality of data acquisition devices enables enhanced data capture from multiple perspectives and using multiple modalities. For example, data acquisition 1 may be a video camera located behind home plate and aimed at the pitching mound as to capture each pitch from a front-on view, whereas data acquisition 2 may be a video camera located along either the first base line or the third base line (in the right field foul area or the left field foul area, respectively) and aimed at the opposing batter's box as to capture a batter swinging a bat at the oncoming pitch. Additional data acquisition devices may be incorporated in the outfield with a full view of the playing field, along the base lines with side views of the pitcher, or in other strategic locations to capture players in the field or base runners. In some embodiments, cameras may be mounted on players, base coaches, or umpires to capture different perspectives. Furthermore, drones may be incorporated to carry cameras and hover in advantageous locations over the playing field to capture additional viewpoints.

These data acquisition devices may be low cost mobile cameras set up in the desired locations alternatively, the data acquisition devices may be high frame rate or ultra-high frame rate cameras as to capture the play with high enough temporal resolution to determine pitch speeds, bat speeds, and player tendencies that cannot be visualized at lower/standard frame rates. The data acquisition devices may also be high resolution cameras to capture additional spatial details. Filters, or wave-length sensitive sensors may also be used to capture additional aspects of the play, such as by visualizing heat signatures of the players, or viewing the play under lower light conditions. The data acquisition devices may also include radar guns or laser guns used to detect the speed of the ball during play, such as pitch speed or hit speed, as well as bat speed.

Still referring to FIG. 1, the system may further include a local user interface 120. In some embodiments, the local user interface 120 may be a tagger used to visualize video streams from one or more of the cameras and/or tag the events with meta data tags. For example, a touch screen device, such as a smart phone, tablet, laptop, personal data assistant, or other mobile computing device may be configured to interface with local control server 130, or directly with data acquisition devices 112, 114, and/or 116, to view data in real time, identify and tag starting and stopping points for each data segment (e.g., the start of a pitch windup to the release of the ball, and the start of a swing to the follow-through of a swing), as well as player information, action-of-interest type, and action-of-interest results. The output from the tagging device may then be transmitted either locally to local control server 130, or remotely via Internet 140 to control server 150.

Control server 150 may include video processing engine 152, data merging engine 154, and rendering engine 156. Control server 150 may communicate with data store 162 and database 164 via a standard network communication protocols (e.g., TCP/IP, HTTP, HTTPS, NFS, CIFS) and/or data storage communication protocols (e.g., SCSI, FIBRE CHANNEL). Local control server 130 may be used as a temporary device running a light-weight instance of the control server, database, and data store, except that the local control server 130 is on a local area network and/or local wireless network with the data acquisition devices 112, 114, and 116, and local user interface 120. Accordingly, Internet connectivity is not required to capture and tag data sets from an athletic event. In such cases, data sets may be uploaded to control server 150 when Internet connectivity becomes available, or data sets may be transferred to Control Server 150 via portable data storage devices such as portable hard drives, thumb drives, or other devices as known in the art.

As previously described, control server 150 may store data sets it receives from data acquisition devices 112, 114, and 116 in data store 162. Data store 162 may be an internal hard drive, SAN, NAS, iSCSI, cloud storage, or other storage device as known in the art. The control server may then parse the data into a plurality of data segments. The data sets may then be parsed using manual user input whereby a user views one or more of the data sets through a user interface and selects starting and stopping points for each data segment. Alternatively, the Control Server 150 may use saliency recognition algorithms, as generally known in the art, to identify salient features of a player-of-interest within a camera's field of view, and identify motions associated with those salient features (e.g., winding up to deliver a pitch or starting to execute a swing of the bat). Control server 150 may then automatically tag starting and stopping times within the data set, and store the parsed data segments in data store 162.

Control server 150 may also index these data segments into a database 164. For example database 164 may be a standard relational databased configured to index and store image data objects and corresponding meta data tags associated with each athletic event. Alternatively, database 164 may be a non-relational database configured to store image data objects and corresponding meta data tags associated with each athletic event. One of ordinary skill in the art would appreciate that there are various manners in which such a data structure may be configured within the database 164. In one example, database 164 may store historical information about all players, games, events/tournaments, and the data sets, data segments, and meta data tags associated with every play captured by the system. This data may be indexed. The database 164 may allow for rosters and tournament data to be loaded in before a tournament and team files to be generated for the onsite equipment. The database 164 may also receive meta data in any format readable from the tagging device and/or user interface 120. In some embodiments, a remote user interface 170 may also connect to control server 150 and database 164 to perform these functions. For example, remote user interface 170 may be web based, or mobile app based and run from a computing device such as a desktop computer, laptop, mobile phone, tablet, or other computing device as known in the art.

In some examples, a cloud solution may be used for database 164 and data store 162. In addition to providing the aforementioned storage capabilities, the database 164 may be used to facilitate logging of user access as well as billing records and maintenance. Storage of all data may be performed in compliance with generally accepted best practices including encryption and hashing as appropriate.

In one example database deployment, access control may be configured in progressively increasing levels for each user type as follows: Single family Annual Subscriptions, Youth coaches Team Annual Subscription, College Recruiter Subscriptions with multiple user accounts and the ability to post recruiting notes and tag prospects, MLB recruiters/scouts, Customer Service/Billing team members, and System administrator.

Also as described above, control server 150 may include a video processing engine 152, a data merging engine 154, and a rendering engine 156. The video processing engine 152 may be configured to process one or more of the data segments into one or more video streams according to a user input. The data merging engine 154 may be configured to synchronize each data segment with one or more corresponding meta data tags and one or more data segments acquired from a different data acquisition device. For example, the synchronization process may trigger off of manually entered start and stop points, or a synch flag that a user identifies within each data set. Accordingly, multiple data sets, and corresponding data segments, from multiple data acquisition devices all capturing content relating to a single action-of-interest, or sequence of actions-of-interest (e.g., a pitch followed by a swing of a bat and a hit) may be merged together by processing the data segments, syncing the data segments, and relationally storing the synced data segments in database 164.

The rendering engine 156 may be configured to generate the multi-content display window with multiple view ports configured to display each of the synchronized and related data segments described above, along with corresponding meta data tags. This multi-content display may be transmitted to a user interface device for review and interaction. For example, the multi-content display window may be transmitted to the user interface device via the Internet using standard Internet protocol such as HTTP or HTTPS, as generally known in the art. The end result may include multiple sets of synchronized and related data segments spanning an entire athletic event, but cutting out non-relevant data content as to only show actions-of-interest from multiple vantage points. Thus, an entire athletic event may be thoroughly replayed in a highly compressed time frame, while still displaying all important events to an end-user.

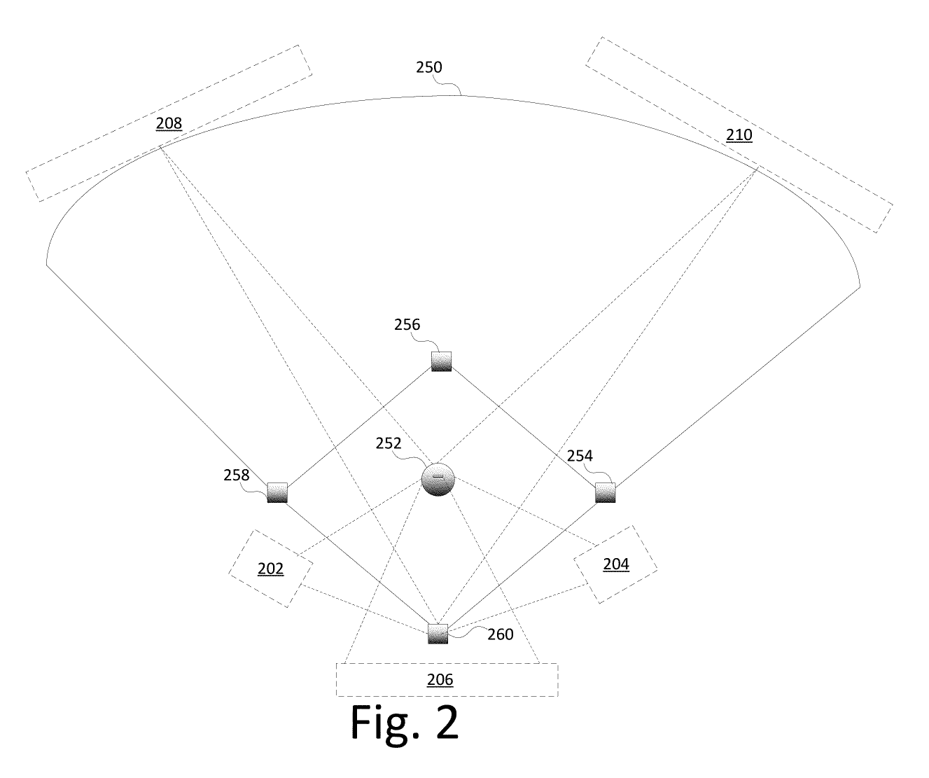

FIG. 2 is a top-down diagram illustrating data capture devices from a system for real-time capture of an athletic event as deployed on a baseball field, consistent with embodiments disclosed herein. As illustrated, data acquisition devices may be located in various positions on a playing field 250 to capture data sets from desired vantage points. For illustrative purposes, a baseball field is illustrated. However, as discussed above, the system disclosed herein may be used on any other types of playing field for other types of athletic events, or in some cases, non-athletic events.

The baseball field 250 includes standard features such as home plate 260, first base pad 254, second base pad 256, third base pad 258, and pitching mound 252. Data acquisition devices may be located behind home plate 260, in area 206, and aimed at the pitching mound 252. In addition, data acquisition devices may be located in the right field foul area, and/or along the first base line, in area 204 and aimed at home plate 260, or the right handed batter's box to the left of home plate 260 (not shown). Similarly, data acquisition devices may be located in the left field foul area, and/or along the third base line, in area 202 and aimed at home plate 260, or the left handed batter's box to the right of home plate 260 (not shown). Additional data acquisition devices in areas 202 and 204 may be aimed at pitching mound 252 to capture a side view of the pitcher. Data acquisition devices may also be placed in the outfield, for example in areas 208 and 210, to capture a wider angle view of the entire playing field, including simultaneous views of the pitcher and batter, as well as other players.

The identified data acquisition locations in FIG. 2 are shown for illustrative purposes only, and one of skill in the art would appreciate that data acquisition devices may be located in other areas along the field, worn by players, coaches, or umpires, placed in base bags and/or the pitching mound itself, hovered overhead using wires or drones, or otherwise strategically placed to incorporate advantageous data acquisition fields of view into the system. Data acquisition devices may also include radar and/or laser guns, as discussed above, to gage ball and bat speeds contemporaneously with video capture. Other measurements devices may also be incorporated into the system, as known in the art.

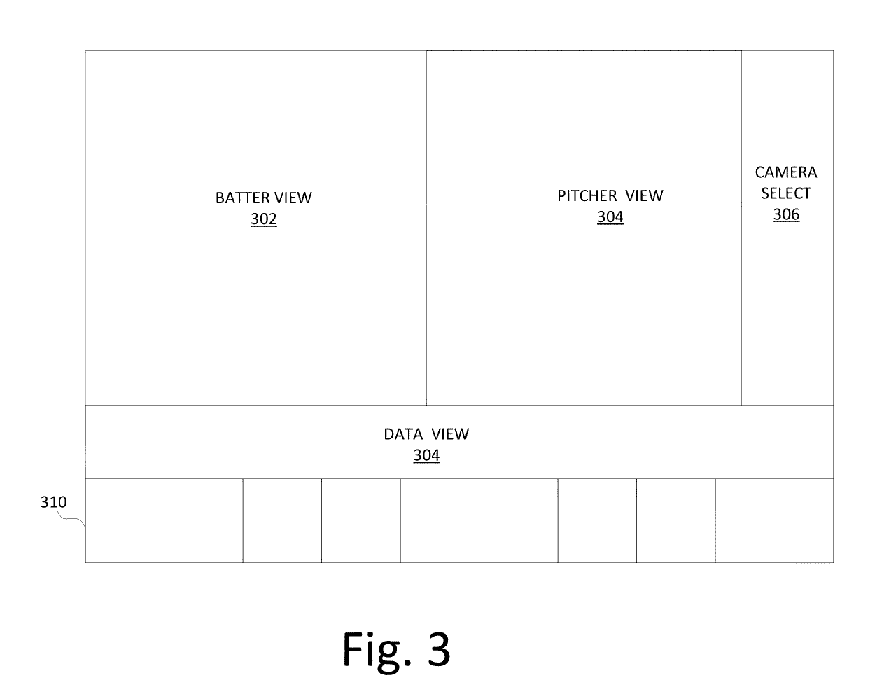

FIG. 3 illustrates an example layout of a user interface screen. As illustrated, a multi-content display window that includes a synchronized content display of a plurality of the video streams and a plurality of the meta data tags may be transmitted from control server 150 to local user interface 120 or remote user interface 170. For example, the multi-content display window may include a split screen with a batter view 302 on the left and a pitcher view 304 on the right, a camera select interface strip to the right of the pitcher view 304, and a data view 304 strip underneath. As content is selectively streamed to the display window, simultaneous and synchronized video streams depicting views of the batter and pitcher may be displayed side-by-side in view ports 302 and 304, with pertinent meta data tags graphically displayed below, such as information about the current hitting situation, number of outs, strikes, balls, men on base, score, pitch count, pitch speed, historical situational data for both the pitcher and batter, and so on. Moreover, data cards for each player in the roster on either team may be shown in utility display area 310. The user interface configuration shown in FIG. 3 is for illustration only, and multiple other interface configurations may be possible as known in the art. For example, a four camera quadrant view could easily be created by splitting the screen horizontally as well as vertically. Other such configurations and display format may be deployed as desired.

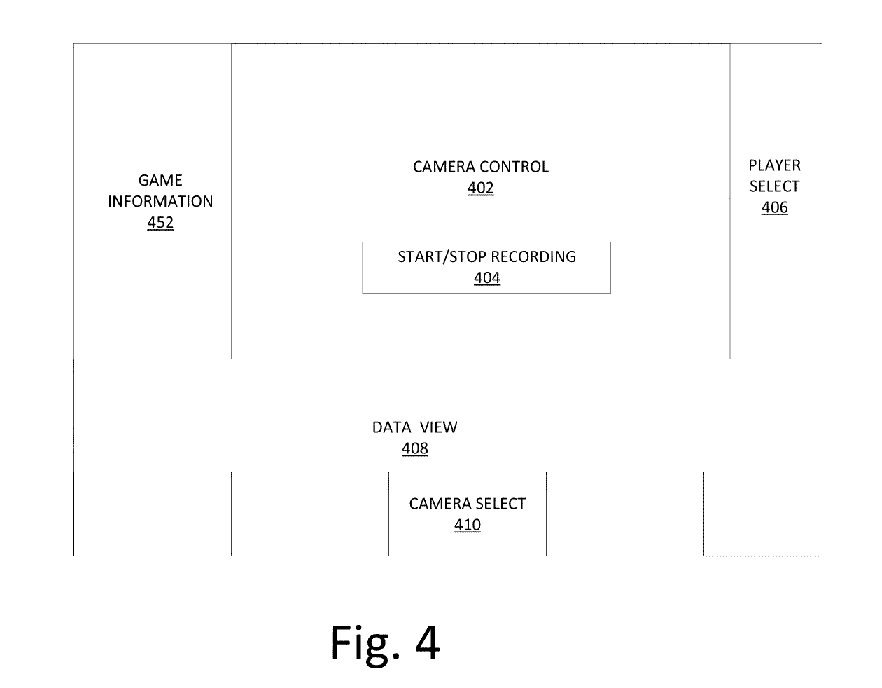

FIG. 4 illustrates another example layout of a user interface screen. Specifically, the user interface screen in FIG. 4 may be used to control one or more data acquisition devices, as well as implement tagging. For example, game information may be displayed in window 452. Window 402 may be used for camera control. For example, a video stream from an acquisition device, as selected in camera select area 410, may be displayed within camera control window 402. The camera control button 404 may then be used to start or stop recording of the camera. Camera control window 402 may also present the user with multiple tagging buttons to quickly select appropriate tags corresponding to the data acquisition. Relevant information about the game, and specific plays, may be populated in data view window 408. The player-of-interest, corresponding the particular video stream being captured and tagged, may be selected from player select window 406. As previously discussed, one or more of these features may be automated. Furthermore, other user interface configurations may be used as would be known in the art.

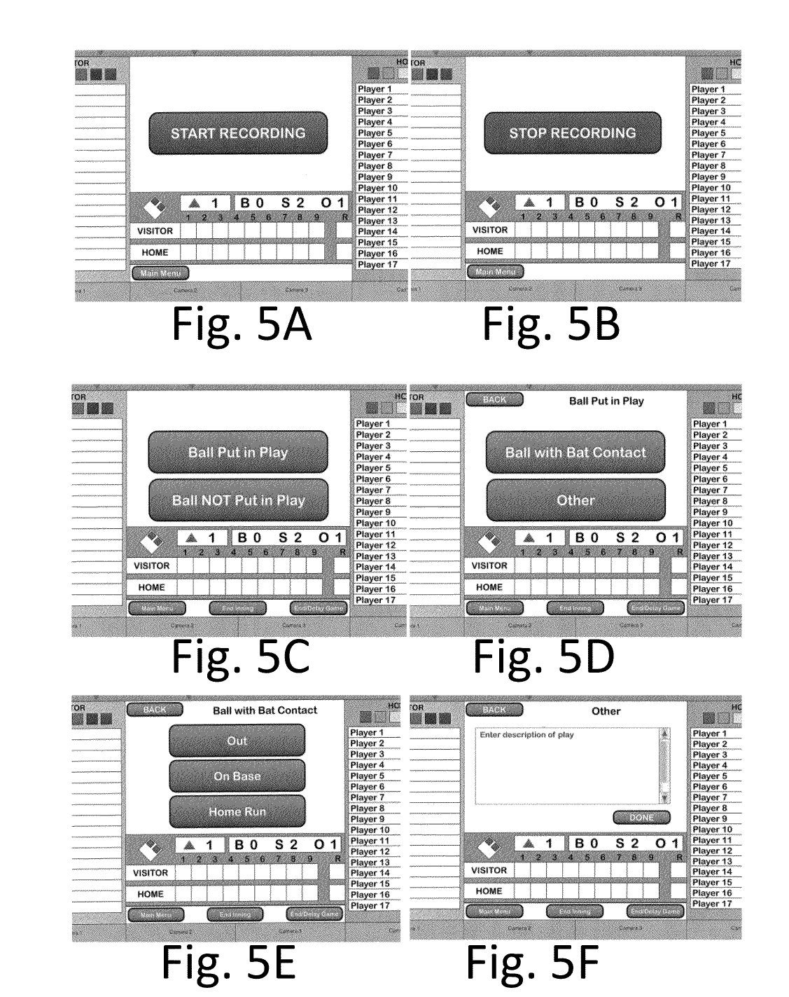

FIGS. 5A-5J illustrate various example implementations of the user interface described with respect to FIG. 4. For example, FIG. 5A shows the START RECORDING button, which may be selected to start capturing video from a selected camera. FIG. 5B shows a STOP RECORDING button to end the video capture. FIGS. 5C-5E illustrate various tagging options to identify a ball put in play, not put in play, ball with bat contact, out, on base, or home run. Each of these selections would be an activity-of-interest type as disclosed herein. FIG. 5D also illustrates an option for manually entering a tag, which could be done using the text entry window illustrated in FIG. 5F. Similarly, FIGS. 5G and 5H illustrate additional tag sequences to identify a ball, strike, foul, or hit by pitch, and then, the outcome event of a hit by pitch. FIG. 5I illustrates a button for END PLAY that may be selected to enter all the meta data tags for the most recent action-of-interest. FIG. 5J shows a screen shot depicting a multi-camera view with a main view port showing a view from a data acquisition device located behind home plate, along with side and back views of the batter in smaller view ports along the bottom of the screen. Editing control and view port configuration options are shown to the right. Again, the configuration illustrated is for example only, and other configurations may be used as would be known in the art.

As described above with respect to FIGS. 4 and 5A-5J, multiple user interface types may be used. For example, an operator user interface may be a cross platform tool that runs on a standard computer platform and enables the capture of a plurality of concurrent video streams of an athletic event along selecting and saving meta data tags correlating to each play, whether by user input, querying the user for input, or logically and programmatically deducing facts based upon the rules of baseball and video interpretation.

The operator user interface may be a full screen application and display the plurality of video streams anywhere on the screen. The operator user interface may be connected in real time to control server 150, but for fault tolerance, may also include a backup. This may include writing video and meta data tags in real time to a file system to minimize data loss, or using data integrity solutions as are generally known in the art.

The operator user interface may have the ability to display a plurality of video feeds along the predetermined locations on a display, and selectively record a series of video streams simultaneously. These video streams may be saved into a desired file format in real-time on data store 162. For example, video streams may be approximately 10 seconds each, although they may be longer or shorter depending on the action-of-interest, and actual playing conditions.

The operator user interface may have the ability to ingest team files created in a standard format from the backend database and may have the ability to store multiple team rosters to facilitate the system's use and adoption at a tournament facility. In the event that rosters are modified due to jersey number changes or alternate players, the roster may be updated to the server as part of the upload process and it may have the ability to move that file to other computers on site to propagate player and team information.

The operator user interface may also have the ability to track a game situation starting from the visiting team's first at bat with the count 0-0 through the final play of the game using the various input mechanisms, such as meta data tag input, as disclosed herein. The operator user interface may, for example, display the current Balls, Strikes, Outs, and Inning, along with men on base.

For example, a particular sequence of related actions-of-interest may be captured as follows: (i) the user starts recording as the pitcher starts his windup (this event may be automatically initiated by detection the pitchers leg start to move off the mound and/or the pitchers arms start to move); (ii) the pitch is delivered, but the ball is not put in play, and the video streams from the pitcher camera and batter camera are saved along with meta data tags, including pitch speed as automatically captured from a radar gun, and the Not Put In Play selection by the user; (iii) the sequence repeats, and this time a ball is thrown, and repeated four times to initiate a walk—the system may automatically identify that a man is on first base, or move additional base runners to the next base accordingly; (iv) three strikes may be thrown, and the system may automatically identify that the batter is out; (v) the pitcher throws to first and the base runner makes it back to avoid a pick off, and the user can select the Nothing tag to indicate that nothing happened—the system can then automatically remove the last recording; (vi) the next pitch may hit the batter, and the batter may either take a base, or may not depending on the local rules of the game and the umpire's decision—the event may be recorded using a meta data tag selection by the user; (vii) the next pitch may be put in play, and the wide angle view from the outfield may then be automatically merged in corresponding to a Put In Play meta data tag selected by the user, or automatically identified by saliency recognition features of the system as described herein. At the conclusion of an at bat, the batter may increment to the next one in the lineup. Similarly, other automatically recognizable events may increment counters (e.g., three strikes is an out, three outs ends the half-inning, etc.).

The operator user interface may also include a backup function which allows the user to go back one play to the previous game situation. There may also be the option to nullify the last recording if it was started in error. A box score may appear on the operator user interface screen and include the full inning by inning scoring along with runs, hits, errors for each team.

The operator user interface may also identify whether the batter is right handed, left handed or a switch hitter and then enable the proper batter camera. This setting may be automated based on spatial recognition of the batter's stance, may be recognized based on the identity of the batter, or may be manually entered as a meta data tag.

The system may be configured to export out an XML format file (or equivalent format) including all the data from the game. This file may include all data about the game including teams, location, date, time, etc. For example, each line may include the pitcher and batter's name, number, and other player identifiable information to correlate back to the main database. The file may also include the count before the pitch (balls, strikes), outs, pitch velocity (mph), what happened as a result of the pitch, men on base, as well as other pieces of information tracked by the system.

The operator user interface may also save and close out games at their conclusion and export “game packages” which may be a complete export of all video and metadata ready to move to a server, a DVD, to an attached hard drive, or another transfer mechanism or location. The game packages may incorporate a security mechanism to prohibit copying and/or modifying the video in any way—ensuring the integrity of the content of the video.

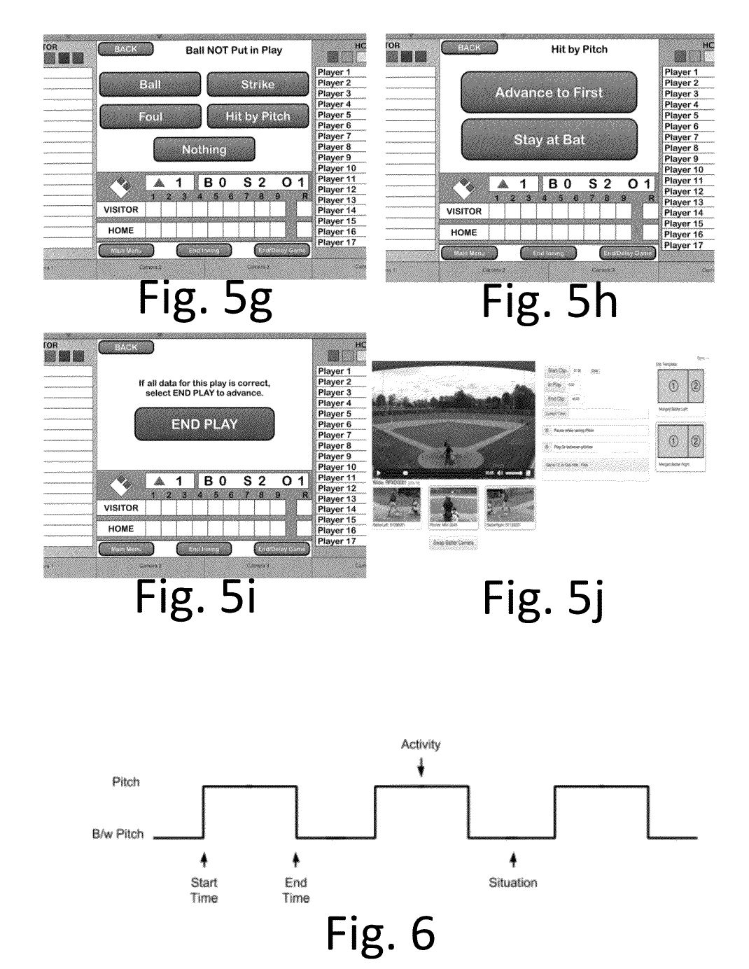

FIG. 6 illustrates a synchronization plot demonstrating how multiple data sets may be parsed into data segments and synced together. As illustrated in FIG. 6, valleys illustrate times when nothing of interest is occurring, whereas peaks indicate times when actions-of-interest (e.g., a pitch or swing of the bat) are occurring. These events can be recognized by the control server using saliency recognition algorithms as described herein to determine moving objects (e.g., a pitcher's leg, arms, and torso) as compared with static background images.

Alternatively, the timing may be manually tagged by a user using the operator user interface as described herein, such that the user identifies when the pitching motion starts, when the ball is released, when the batter initiates a swing, when the ball reaches the bat, and when the swing is completed. Each of these events may be a peak within a corresponding data set (i.e., the pitcher camera data set for the pitcher related events, and the batter camera data set for the batter related events). The control server may then use the identified start and stop points identified in each synchronization plot, match those points to an a master synchronization plot to identify when, for example, a pitch leaving the pitcher's hand at a particular speed will arrive at home plate, and when the batter should or would likely initiate a swing, in order to synchronize the pitcher data set with the batter data set. This description provides an example for how synchronization of data sets may be automated. Manual synchronization by visually displaying the pitcher data set and batter data set side-by-side, and selecting a synchronization point, may also be implemented in the system disclosed.

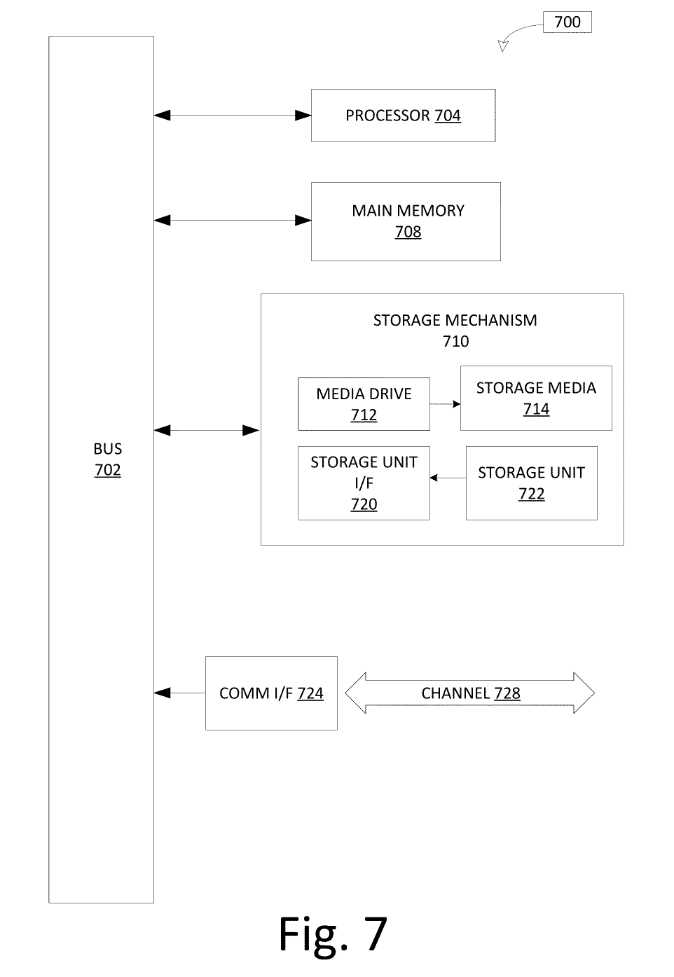

As used herein, the term module might describe a given unit of functionality that can be performed in accordance with one or more embodiments of the technology disclosed herein. As used herein, a module might be implemented utilizing any form of hardware, software, or a combination thereof. For example, one or more processors, controllers, ASICs, PLAs, PALs, CPLDs, FPGAs, logical components, software routines or other mechanisms might be implemented to make up a module. In implementation, the various modules or computer engines described herein might be implemented as discrete modules or engines, or the functions and features described can be shared in part or in total among one or more modules or engines. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules or engines of the technology are implemented in whole or in part using software, in one embodiment, these software elements can be implemented to operate with a computing or processing module capable of carrying out the functionality described with respect thereto. One such example computing module is shown in FIG. 7. Various embodiments are described in terms of this example-computing module 700. After reading this description, it will become apparent to a person skilled in the relevant art how to implement the technology using other computing modules or architectures.

Referring now to FIG. 7, computing module 700 may represent, for example, computing or processing capabilities found within desktop, laptop and notebook computers; hand-held computing devices (PDA's, smart phones, cell phones, palmtops, etc.); mainframes, supercomputers, workstations or servers; or any other type of special-purpose or general-purpose computing devices as may be desirable or appropriate for a given application or environment. Computing module 700 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 700 might include, for example, one or more processors, controllers, control modules, or other processing devices, such as a processor 704. Processor 704 might be implemented using a general-purpose or special-purpose processing engine such as, for example, a microprocessor, controller, or other control logic. In the illustrated example, processor 704 is connected to a bus 702, although any communication medium can be used to facilitate interaction with other components of computing module 700 or to communicate externally.

Computing module 700 might also include one or more memory modules, simply referred to herein as main memory 708. For example, preferably random access memory (RAM) or other dynamic memory, might be used for storing information and instructions to be executed by processor 704. Main memory 708 might also be used for storing temporary variables or other intermediate information during execution of instructions to be executed by processor 704. Computing module 700 might likewise include a read only memory (“ROM”) or other static storage device coupled to bus 702 for storing static information and instructions for processor 704.

The computing module 700 might also include one or more various forms of information storage mechanism 710, which might include, for example, a media drive 712 and a storage unit interface 720. The media drive 712 might include a drive or other mechanism to support fixed or removable storage media 714. For example, a hard disk drive, a floppy disk drive, a magnetic tape drive, an optical disk drive, a CD or DVD drive (R or RW), or other removable or fixed media drive might be provided. Accordingly, storage media 714 might include, for example, a hard disk, a floppy disk, magnetic tape, cartridge, optical disk, a CD or DVD, or other fixed or removable medium that is read by, written to or accessed by media drive 712. As these examples illustrate, the storage media 714 can include a computer usable storage medium having stored therein computer software or data.

In alternative embodiments, information storage mechanism 710 might include other similar instrumentalities for allowing computer programs or other instructions or data to be loaded into computing module 700. Such instrumentalities might include, for example, a fixed or removable storage unit 722 and an interface 720. Examples of such storage units 722 and interfaces 720 can include a program cartridge and cartridge interface, a removable memory (for example, a flash memory or other removable memory module) and memory slot, a PCMCIA slot and card, and other fixed or removable storage units 722 and interfaces 720 that allow software and data to be transferred from the storage unit 722 to computing module 700.

Computing module 700 might also include a communications interface 724. Communications interface 724 might be used to allow software and data to be transferred between computing module 700 and external devices. Examples of communications interface 724 might include a modem or soft modem, a network interface (such as an Ethernet, network interface card, WiMedia, IEEE 802.XX or other interface), a communications port (such as for example, a USB port, IR port, RS232 port Bluetooth® interface, or other port), or other communications interface. Software and data transferred via communications interface 724 might typically be carried on signals, which can be electronic, electromagnetic (which includes optical) or other signals capable of being exchanged by a given communications interface 724. These signals might be provided to communications interface 724 via a channel 728. This channel 728 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to media such as, for example, memory 708, storage unit 720, media 714, and channel 728. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 700 to perform features or functions of the disclosed technology as discussed herein.

While various embodiments of the disclosed technology have been described above, it should be understood that they have been presented by way of example only, and not of limitation. Likewise, the various diagrams may depict an example architectural or other configuration for the disclosed technology, which is done to aid in understanding the features and functionality that can be included in the disclosed technology. The disclosed technology is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the technology disclosed herein. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the disclosed technology is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the disclosed technology, whether or not such embodiments are described and whether or not such features are presented as being a part of a described embodiment. Thus, the breadth and scope of the technology disclosed herein should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A system for video capture and display comprising:
a plurality of data acquisition devices, a tagging device, a control server, a database, a data store, and a user interface device;
wherein each data acquisition device is configured to contemporaneously capture a data set relating to an athletic event;
the control server is configured to receive the data sets, store the data sets in the data store, parse each data set into a plurality of data segments, and index the plurality of data segments in the database;
the tagger device is configured to accept a user input that labels each data segment with one or more meta data tags, and transmit each of the meta data tags to the control server; and
the user interface is configured to control a data acquisition state of each data acquisition device, interface with the control server, and receive a multi-content display window from the control server.

2. The system of claim 1, wherein the plurality of data acquisition devices comprises a plurality of digital video cameras.

3. The system of claim 2, wherein each of the plurality of video cameras is positioned on a playing field to capture a distinct field of view.

4. The system of claim 3, wherein the distinct field of view encompasses a player-of-interest.

5. The system of claim 4, wherein the player-of-interest is a baseball batter.

6. The system of claim 4, wherein player-of-interest is a baseball pitcher.

7. The system of claim 4, wherein the playing field is a baseball field and one of the plurality of cameras is located behind a home plate and aimed at a pitching mound.

8. The system of claim 4, wherein the playing field is a baseball field and one of the plurality of cameras is located in a right field foul area and aimed at a right-handed batter's box and another of the plurality of cameras is located in a right field foul area and aimed at a left-handed batter's box.

9. The system of claim 1, wherein the plurality of data acquisition devices comprises a radar gun configured to capture the speed of a pitch.

10. The system of claim 1, wherein each data segment corresponds to an action-of-interest performed by a player-of-interest.

11. The system of claim 10, wherein the action-of-interest comprises a pitcher's pitch or a batter's swing.

12. The system of claim 1, wherein each meta data tag comprises a player-of-interest's name, an action-of-interest type, or an action-of-interest result.

13. The system of claim 12, wherein the action-of-interest type comprises a pitch or an attempted hit, and the action-of-interest result comprises a strike, a ball, a hit, a foul, a miss, or a non-swing.

14. The system of claim 1, wherein the control server comprises a video processing engine, a data merging engine, and a rendering engine, wherein:
the video processing engine is configured to process one or more of the data segments into one or more video streams according to a user input;
the data merging engine is configured to synchronize each data segment with one or more corresponding meta data tags and one or more data segments acquired from a different data acquisition device; and
the rendering engine is configured to generate the multi-content display window comprising a synchronized content display of a plurality of the video streams and a plurality of the meta data tags.

15. A method for video capture and display comprising:
locating a plurality of digital cameras on a playing field such that each digital camera is positioned to capture a player-of-interest;
selectively initiating contemporaneous video capture of one or more video streams, wherein each video stream captures an action-of-interest executed by the player-of-interest;
storing the one or more video streams on a data store;
generating one or more meta data tags corresponding to each video stream;
receiving, with a control server, the one or more video streams and the one or more meta data tags, the control server comprising a data merging engine and a rendering engine;
synchronizing, with the data merging engine, each video stream with one or more corresponding meta data tags and one or more video streams acquired from a different digital camera; and
generating, with the rendering engine, a multi-content display window comprising a synchronized content display of a plurality of the video streams and a plurality of the meta data tags.

16. The method of claim 15, wherein playing field comprises a baseball field.

17. The method of claim 16, wherein the locating the plurality of digital cameras comprises positioning a first digital camera behind a home plate and aiming the first digital camera at a pitching mound.

18. The method of claim 17, wherein the locating the plurality of digital cameras further comprises:
positioning a second digital camera in a right field foul area;
positioning a third digital camera in a left field foul area;
aiming the second digital camera at a right-handed batter's box; and
aiming the third digital camera at a left-handed batter's box.

19. The method of claim 18, wherein each meta data tag comprises a player-of-interest name, an activity-of-interest type, an activity-of-interest result, or a pitch speed.

20. The method of claim 19, wherein the generating the one or more meta data tags comprises tagging video stream data using a tagging device, capturing pitch speed using a radar gun device, identifying the player-of-interest name using facial recognition, identifying the player-of-interest name using shape recognition of jersey numbers, identifying the player-of-interest name using a barcode scanner to scan a bar code on a player-of-interest's jersey, identifying the player-of-interest name using a radio frequency identification (RFID) scanner to scan a RFID on a player-of-interest's article of clothing, or identifying the activity-of-interest result using an umpire user interface device.
